(19) United States
(12) Patent Application Publication
(10) Pub. No.: US 2024/0396349 A1
(43) Pub. Date: Nov. 28, 2024

(54) FLIP SWITCH SYSTEM FOR RECHARGEABLE POWER STORAGE DEVICES

(71) Applicant: SPARKION POWER ALGORITHMS LTD, Herzliya (IL)

(72) Inventors: Shmuel BEN YAAKOV, Tel Yitzhak (IL); Tomer BENTZION, Tel Aviv (IL)

(21) Appl. No.: 18/689,304

(22) PCT Filed: Sep. 6, 2022
(86) PCT No.: PCT/IL2022/050970

§ 371 Date: Mar. 5, 2024

Related U.S. Application Data
(60) Provisional application No. 63/241,006, filed on Sep. 6, 2021.

(51) Int. Cl. H02J 7/00; H02J 7/34

(52) U.S. Cl. CPC H02J 7/0024; H02J 7/0019; H02J 7/0048; H02J 7/345

(57) ABSTRACT

A system for operating an array of power storage devices having an output voltage, comprising an array of power storage devices, each is coupled to a two-port switching circuit and being serially connected to each other via the two-port switching circuit, such that during normal operation, the positive port of each power storage device is connected to the negative port of its subsequent power storage device, except for the power storage device having the highest voltage point, which is an output terminal of the array; a controller for controlling each of the two-port switching circuit, which is adapted to detect that an exceptional power storage device in the array has charging or powering characteristics that are outside a predetermined threshold window with respect to the remaining power storage devices in the array: electrically bypass the exceptional power storage device by directly connecting between the two ports of the switching circuit of the power storage, while excluding the exceptional power storage device from the connection, or; electrically flip, by the two-port switching circuit, the connection polarity of the exceptional power storage device, such that during a powering mode, when the array feeds a load, the exceptional power storage device will be charged by the current supplied to the load via all power storage devices of the array and during a charging mode, when the array is charged by a power source, the exceptional power storage device will be discharged by the charging current flowing through all the power storage devices of the array.f

### FIELD OF THE INVENTION

The present invention relates to the field of power storage devices. More particularly, the present invention relates to a system and method for controlling the efficiency of an array of rechargeable power storage devices, during powering and charging modes.

### BACKGROUND OF THE INVENTION

Arrays of rechargeable power storage devices are widely used in many applications. The power storage devices may include reparable batteries, large capacitors, supercapacitors (high-capacity capacitor with a capacitance value much higher than other capacitors, but with lower voltage limits, that bridges the gap between electrolytic capacitors and rechargeable batteries), fuel cells (devices that generate electricity through an electrochemical reaction. In a fuel cell, hydrogen and oxygen are combined to generate electricity, heat, and water) and other energy storage components. Such power storage devices are typically connected in series to obtain a desired voltage level. An optimal arrangement of such arrays requires that the connected power storage devices will have similar characteristics, in order to make the powering and charging modes essentially balanced.

In most applications (such as electric vehicles), new (fresh) batteries are connected in series (to provide high voltages) and/or in parallel (to provide high currents) and the charging and powering modes are controlled by a Battery Management System (BMS—an electronic control circuit that monitors and regulates the charging and discharge of batteries). In order to allow efficient management, the batteries should have essentially similar characteristics. However, in contrast to new batteries, second life batteries have lower quality and less similar characteristics. Therefore, the connection of such batteries will lead to a state where, for example, during a charging mode, some batteries will be charged less than other batteries. To remedy this problem, several approaches can be used to balance the charge of the batteries. One approach is a passive BMS, in which the batteries of higher charge are discharged via a resistor. This of course causes power loss. Another possible approach is to use an active BMS that transfers energy from one cell to another. The circuitry of this approach is complex and it also suffers from considerable loss.

Batteries are not useless when they come to the end of their useful first life. Second life batteries are batteries that can be applied for different usage after their initial lifecycle has come to an end. Giving a second life to batteries, by reusing them in different but still effective ways, also leads to economic benefits. The development of viable second life batteries and battery packs can reduce the amount of waste. As part of the ecosystem of solutions for the energy transition, storage and batteries are tools to enable sustainability and, at the same time, they themselves must be fully sustainable.

Second life batteries have reached the end of their automotive service life but still, have a residual capacity of about 70-80%. Therefore, they can be used in stationary systems, in combination with renewable energy generation, such as wind and solar, or to supply services to the electricity network.

FIG. 1 shows an array 10 of serially connected batteries B₁, . . . , Bₙ with different characteristics that feeds a load 11 with current I. It can be seen that during powering mode, the charge in battery Bₙ is smaller than the charge in batteries B₁ and B₂.

FIG. 2 shows an array 10 of serially connected batteries B₁, . . . , Bₙ with different characteristics that are charged from a charger 12. It can be seen that during charging mode, battery Bₙ is less charged than batteries B₁ and Bₙ.

The fact that one battery in the array 10 is less charged comparing to the other batteries will limit the ability of the entire array to power the load, since upon delivering its (smaller) charge, the powering mode ends, without exploiting the remaining charge in all other batteries. Similarly, during charging, if the charging capability one of the batteries is less than of the other batteries, an attempt to charge it may cause overcharging them, which is dangerous.

Therefore, uneven energy capacity during charge and powering (discharge) modes (caused by the weakest battery cell in the chain) deteriorates the performance of the entire array.

One conventional way to solve the uneven charging problem during charging mode is shown in FIG. 3. A BMS is employed to discharge batteries that were charged more rapidly (B₁ and B₂) using passive balancing. In this way, the excess energy of charging B₁ and B₂ is discharged into a resistor which is connected across each battery via a controlled switch. However, this solution entails energy waist, as a substantial charge is absorbed until the weakest battery Bₙ is fully (or maximally) charged.

A conventional way to solve uneven charging during powering mode is shown in FIG. 4. A BMS is employed to bypass the weakest battery B₂ and simultaneously to individually connect it to a charger 12. In order to keep the total voltage stable, upon bypassing, an additional battery B₂ is added to the array. This way, the weakest battery B₂ is charged until it is fully charged. However, due to the high voltage of the array, this solution is cumbersome and complicated, since the charger 12 should be floating (otherwise the charger should stand very high voltages).

There are applications that use arrays of second life battery cells. Since each second life battery cell may have different characteristics, such applications require a process of sorting the battery cells, in order to know the capacity of each one before assembly of an array.

Such sorting is a cumbersome process, which requires discharging and testing each battery cell.

It is therefore an object of the present invention to provide a system and method for controlling the efficiency of an array of rechargeable power storage devices during powering and charging modes.

It is another object of the present invention to provide a system and method for reducing energy waste during powering and charging modes.

It is a further object of the present invention to provide a system and method for reducing unexploited charge accumulated in batteries connected to an array.

It is still another object of the present invention to provide a system and method for eliminating the need to sort battery cells before connecting them to form an array.

Other objects and advantages of the invention will become apparent as the description proceeds.

### SUMMARY OF THE INVENTION

A method for operating an array of power storage devices having an output voltage Vo, each having a positive port and a negative port, comprising:
a) providing an array of power storage devices (such as a rechargeable battery, a super capacitor or a fuel cell), each of which being coupled to a two-port switching circuit and being serially connected to each other via the two-port switching circuit, such that during normal operation, the positive port of each power storage device is connected to the negative port of its subsequent power storage device, except for the power storage device having the highest voltage point, which is an output terminal of the array;
b) upon detecting that an exceptional power storage device in the array has charging or powering characteristics that are outside a predetermined threshold window with respect to the remaining power storage devices in the array:
   b.1) electrically bypassing the exceptional power storage device by directly connecting between the two ports of the switching circuit of the power storage, while excluding the exceptional power storage device from the connection, or;
   b.2) electrically flipping, by the two-port switching circuit, the connection polarity of the exceptional power storage device, such that during a powering mode, when the array feeds a load, the exceptional power storage device will be charged by the current supplied to the load via all power storage devices of the array and during a charging mode, when the array is charged by a power source, the exceptional power storage device will be discharged by the charging current flowing through all the power storage devices of the array.

Whenever the exceptional power storage device is bypassed or flipped, the output voltage of the array is equalized to be within a desired value Vo by serially connecting a standby equivalent power storage device to the array via a switching circuit.

Whenever the connection polarity of the exceptional power storage device is flipped, equalizing the output voltage of the array to be Vo by serially connecting two standby equivalent power storage devices to the array via a switching circuit.

During powering mode, the standby equivalent power storage devices may be charged after connection to the array, via a power source being referred to a predetermined reference voltage or to ground.

The two-port switching circuit may be a full bridge consisting of:
two pairs of serially connected controllable switches (such as transistors or contactors), the two pairs are parallelly connected to each other and to the ports of the power storage device;
a first port being connected to the mutual connection of one pair; and
a second port being connected to the mutual connection of the other pair.

The power source may be a charger being referred to a predetermined reference voltage or to ground.

The rechargeable battery may be a first or a second life battery.

The transistors may be BJTs or MOSFETs IGBT.

Soft switching may be performed in the two-port switching circuit whenever the controllable switches are MOSFETs, each having an inherent diode, by:
a) controlling one MOSFET not to conduct while allowing current to initially flow via its inherent diode;
b) controlling the MOSFET to conduct after the voltage over the inherent diode drops toward zero voltage.

Charging may be performed using PWM, including a combination of predetermined charging time periods in maximum current and predetermined charging time periods in zero current and optionally predetermined charging time discharging periods.

The method may further comprise the steps of:
a) adjusting the output voltages of two or more arrays by electrically bypassing one or more power storage device in at least one array, to have essentially similar output voltages;
b) adjusting the output voltages of two or more arrays by electrically flipping the connection polarity of one or more power storage device in at least one array, to have essentially similar output voltages; and
c) connecting one or more arrays having adjusted output voltages in parallel.

Each full bridge may be controlled by a control circuit having a communication port, the control circuit being fed externally from the power storage device connected to the full bridge and is adapted to sample the voltage and the charging/powering current of the power storage device.

The output voltage of the entire array is reversed by electrically flipping the connection polarity of more than half of the power storage devices in the array (or of all the power storage devices), while at the same time, equalizing the charge over all power storage devices during charging and powering modes.

A method for operating an array of power storage devices having an output voltage Vo, each having a positive port and a negative port, comprising:
a) providing an array of power storage devices, each of which being coupled to a two-port switching circuit and being serially connected to each other via the two-port switching circuit, such that during normal operation, the positive port of each power storage device is connected to the negative port of its subsequent power storage device, except for the power storage device having the highest voltage point, which is an output terminal of the array;
b) whenever required:
   b.1) electrically bypassing the exceptional power storage device by directly connecting between the two ports of the switching circuit of the power storage, while excluding the exceptional power storage device from the connection, or;
   b.2) electrically flipping, by the two-port switching circuit, the connection polarity of the exceptional power storage device, such that during a powering mode, when the array feeds a load, the exceptional power storage device will be charged by the current supplied to the load via all power storage devices of the array and during a charging mode, when the array is charged by a power source, the exceptional power storage device will be discharged by the charging current flowing through all the power storage devices of the array.

A system for operating an array of power storage devices having an output voltage, comprising:
c) an array of power storage devices, each of which being coupled to a two-port switching circuit and being serially connected to each other via the two-port switching circuit, such that during normal operation, the positive port of each power storage device is connected to the negative port of its subsequent power storage device, except for the power storage device having the highest voltage point, which is an output terminal of the array;
d) a controller for controlling each of the two-port switching circuit, which is adapted to:
e) detect that an exceptional power storage device in the array has charging or powering characteristics that are outside a predetermined threshold window with respect to the remaining power storage devices in the array;
f) electrically bypass the exceptional power storage device by directly connecting between the two ports of the switching circuit of the power storage, while excluding the exceptional power storage device from the connection, or;
g) electrically flip, by the two-port switching circuit, the connection polarity of the exceptional power storage device, such that during a powering mode, when the array feeds a load, the exceptional power storage device will be charged by the current supplied to the load via all power storage devices of the array and during a charging mode, when the array is charged by a power source, the exceptional power storage device will be discharged by the charging current flowing through all the power storage devices of the array.

The system may further comprise:
a) a standby equivalent power storage device;
b) a switching circuit for connecting and disconnecting the standby equivalent power storage device from the array,
wherein whenever the exceptional power storage device is bypassed or flipped by the controller, the controller equalizes the output voltage of the array to be within a desired value Vo by serially connecting the standby equivalent power storage device to the array.

The system may further comprise a power source being referred to a predetermined reference voltage or to ground, for charging the standby equivalent power storage device upon or after serially connecting the standby equivalent power storage device to the array.

A controlled power storage apparatus having a positive port and a negative port, comprising:
a) a power storage device having a positive port and a negative port;
b) a two-port controllable switching circuit, to which the positive and negative ports are coupled, the two-port switching circuit having control inputs and being adapted to;
   b.1) upon receiving a first set of control commands at the control inputs, connect the positive port to a first port of the power storage device and the negative port to a second port of the switching circuit;
   b.2) upon receiving a second set of control commands, electrically bypass the power storage device by controlling the control inputs to directly connect between the two ports of the switching circuit; and
   b.3) upon receiving a third set of control commands, connect the negative port to the first port of the switching circuit and the positive port to the second port of the switching circuit, to thereby electrically flip the connection polarity of the power storage device.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 shows an array of serially connected batteries B₁, . . . , Bₙ with different characteristics that feeds a load with a constant current;

FIG. 2 shows an array of serially connected batteries B₁, . . . , Bₙ with different characteristics that are charged from a charger;

FIG. 3 shows a conventional way to solve the uneven charging problem during charging mode using a BMS to discharge batteries using passive balancing;

FIG. 4. shows a BMS that is employed to bypass a weak battery and simultaneously to individually connect it to a floating charger;

FIG. 5 illustrates a switching circuit for flipping the polarity of the weakest battery in an array of serially connected batteries;

FIGS. 6A-6C illustrate the stage of voltage equalization according to an embodiment of the invention;

FIG. 7A shows the transfer charge to the weakest battery cell and to the load, to compensate for the reduced charge;

FIG. 7B shows using a charger which is referred to ground, rather than using a floating charger;

FIG. 8 illustrates a full bridge implementation of the switching circuit required for performing the bypass and polarity flipping operations, according to a preferred embodiment of the invention;

FIGS. 9A-9C illustrate the switching combinations required for performing the bypass and polarity flipping operations, according to a preferred embodiment of the invention;

FIGS. 10A-10C illustrate the switching combinations required for performing normal, bypass and polarity flipping operations for an array of three battery cells B₁-B₃ during powering mode, according to a preferred embodiment of the invention;

FIGS. 11A-11C illustrate the switching combinations required for performing normal, bypass and polarity flipping operations for an array of three battery cells B₁-B₃ during charging mode, according to a preferred embodiment of the invention;

FIGS. 12A and 12B show the effect of charge (and energy) transfer to the load and to the weakest battery cell B₂ before and after the completion of the powering stage;

FIGS. 13A-13D show flipping the polarity of a weaker battery cell using a partial soft switching;

FIG. 14 shows an example of operating in global PWM during charging mode;

FIG. 15 shows a parallel connection of two arrays of serially connected batteries, each having the capability of flipping the polarity of one or more cells; and

FIG. 16 shows a possible implementation of a flip switch module, according to an embodiment of the invention.

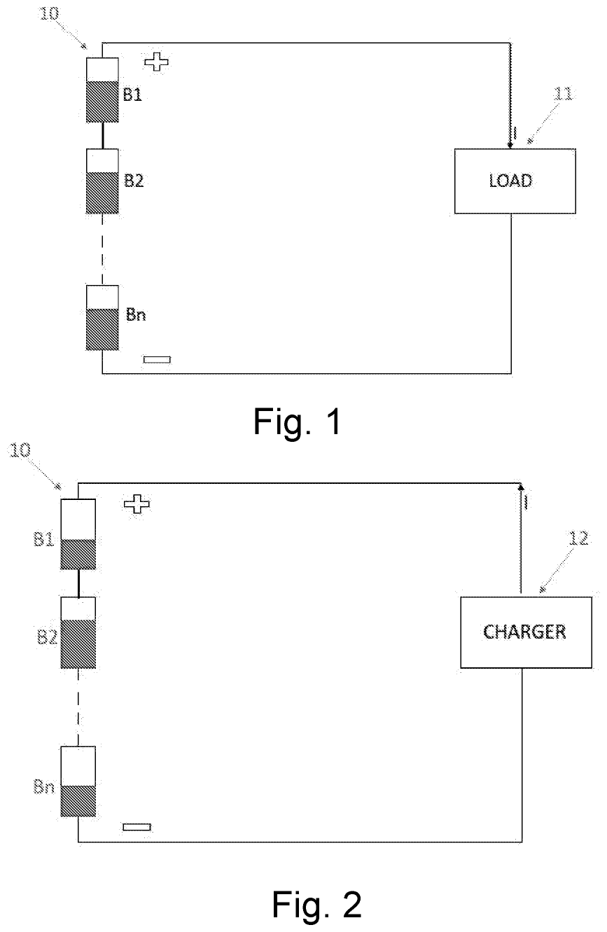

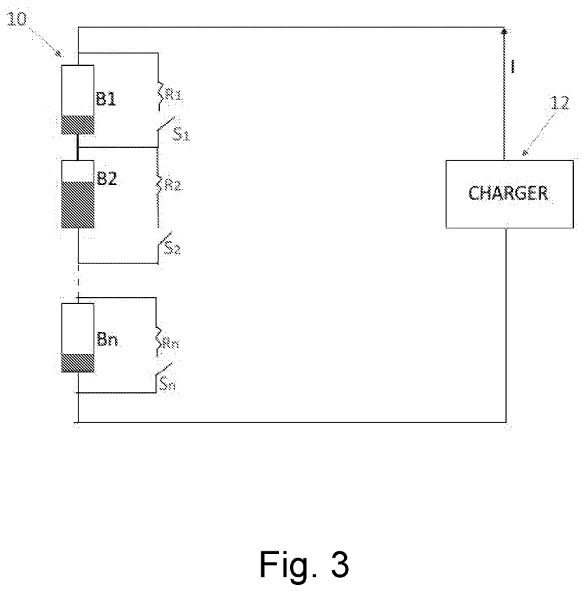

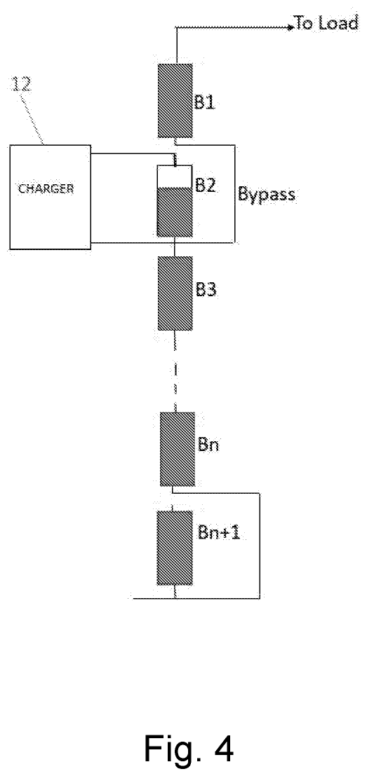

### DETAILED DESCRIPTION OF THE PRESENT INVENTION

The present invention proposes a system and method for controlling the efficiency of an array (or several arrays) or a string of rechargeable power storage devices (each having a positive port and a negative port) during powering and charging modes, while reducing unexploited charge accumulated in batteries connected to an array during powering mode and reducing energy waste during charging mode. The term power storage device include a rechargeable battery cell, a super capacitor, a fuel cell or a combination of several battery cells which are electrically connected, to form a rechargeable battery module that has a negative and a positive port with a predetermined output voltage.

It should be emphasized that the array of battery cells can consist of first life (fresh) batteries, second life batteries or a combination thereof, and the system and method of the present invention can efficiently manage the energy and voltage of the array, particularly when each first life (fresh) battery becomes a second life battery over time.

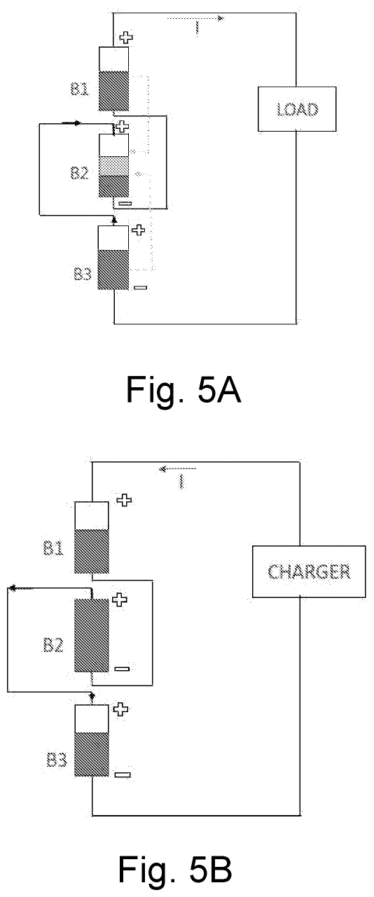

FIGS. 5A-5B illustrate the solution provided by the present invention. In this example, the polarity of the weakest battery B₂ flipped in the array (of serially connected batteries). As a result, during powering mode (when all batteries are being discharged as they feed the load), the weakest battery B₂ will be charged, since the current will flow into its positive port, as shown in FIG. 5A. As a result of flipping, batteries B₁ and B₃ contribute charge to battery B₂, so as to equalize the charge among all participating batteries in the array. During the charging mode (when all batteries are charged), the weakest battery B₂ (which was charged more rapidly than the other batteries) will be discharged, since the current will flow into its negative port, as shown in FIG. 5B. In this mode, as well, the most charged battery will be discharged, in order to reach charge equalization. In some application, this solution may require equalizing the total voltage across the array to keep it essentially constant during charging and powering modes.

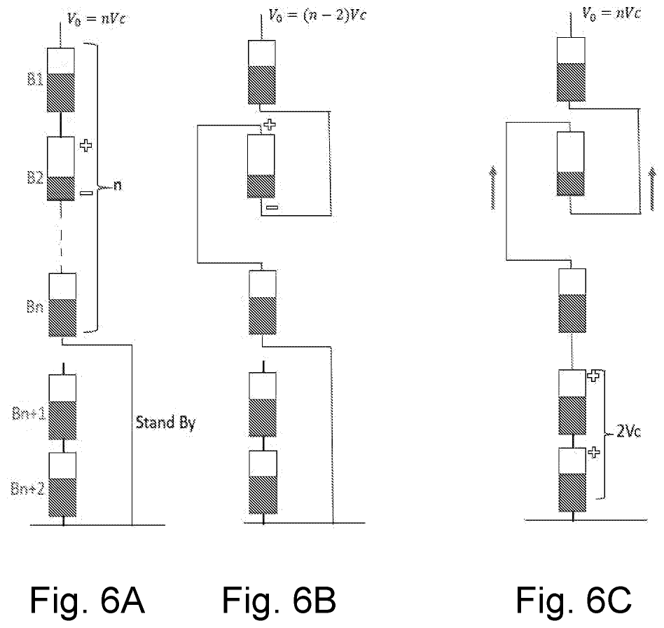

FIGS. 6A-6C illustrate the stage of voltage equalization according to an embodiment of the invention (whenever such equalization is required, depending on the application). FIG. 6A shows an array of n battery cells B₁, . . . , Bₙ, where the weakest battery cell is B₂, before flipping its polarity. In this connection, the output voltage Vo of the array is Vo=n. Vc, where Vc is the voltage provided by a single battery cell (or module). Upon flipping the polarity of the weakest battery cell B₂ and connecting it to the array, the output voltage Vo drops to (Vo=n−2)·Vc, since by flipping the polarity, the weakest battery cell B₂ stops contributing its voltage to the array (resulting in Vo=(n−1). Vc) and further reduces the total voltage of the array by Vc, due to the opposite connection (resulting in Vo=(n−1)·Vc−Vc=(n−2)·Vc)=nVc−2Vc), as shown in FIG. 6B. In order to compensate for the reduction of the total voltage of the array by 2Vc, two standby battery cells Bₙ₊₁ and Bₙ₊₂ are added to the array, while contributing a voltage of 2Vc to the total voltage, as shown in FIG. 6C. As a result, the output voltage Vo of the array is now Vo=nVc−2Vc+2Vc=nVo, as before flipping.

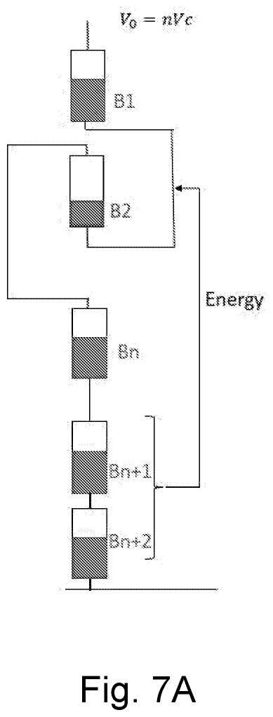

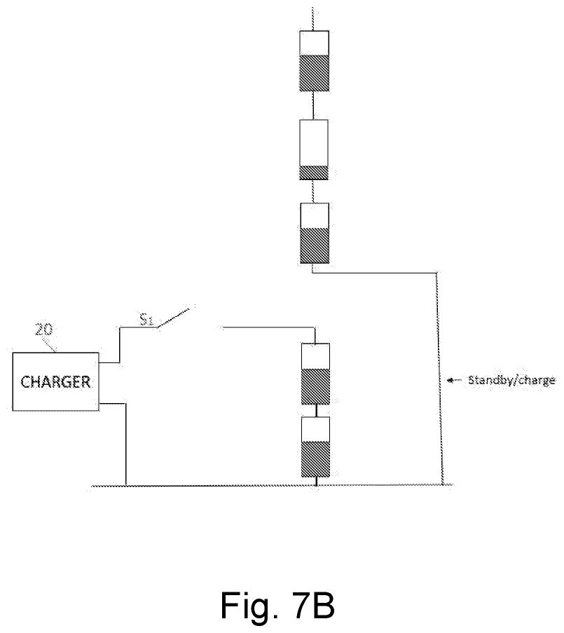

During powering mode, the two standby battery cells Bₙ₊₁ and Bₙ₊₂ along with battery cells B₁ and Bₙ, transfer charge (and energy) to the weakest battery cell B₂ to compensate for its reduced charge, and to the load (as shown in FIG. 7A). Upon completing the charging of the weakest battery cell B₂, the array returns to normal powering operation where all the battery cells are essentially balanced. At this stage, the two standby battery cells Bₙ₊₁ and Bₙ₊₂ can be disconnected from the array and charged by a charger 20 via controllable switch S1, in order to be ready for the next compensation cycle (as shown in FIG. 7B). The advantage is that this arrangement allows using a charger which is referred to any predetermined reference voltage, such as ground (rather than using a floating charger). Optionally, the charger 20 may continue to charge the standby battery cells Bₙ₊₁ and Bₙ₊₂ even during the powering mode.

The present invention also provides a controlled power storage apparatus that has a positive port and a negative port and is capable of bypassing or reversing its polarity. This controlled power storage apparatus comprises a power storage device having a positive port and a negative port and a two-port controllable switching circuit, to which the positive and negative ports are coupled. The two-port switching circuit has control inputs, and upon receiving a first set of control commands at the control inputs, it connects the positive port to a first port of the power storage device and the negative port to a second port of the switching circuit. Upon receiving a second set of control commands, it electrically bypasses the power storage device by controlling the control inputs to directly connect between the two ports of the switching circuit and upon receiving a third set of control commands, it connects the negative port to the first port of the switching circuit and the positive port to the second port of the switching circuit, to thereby electrically flip the connection polarity of the power storage device.

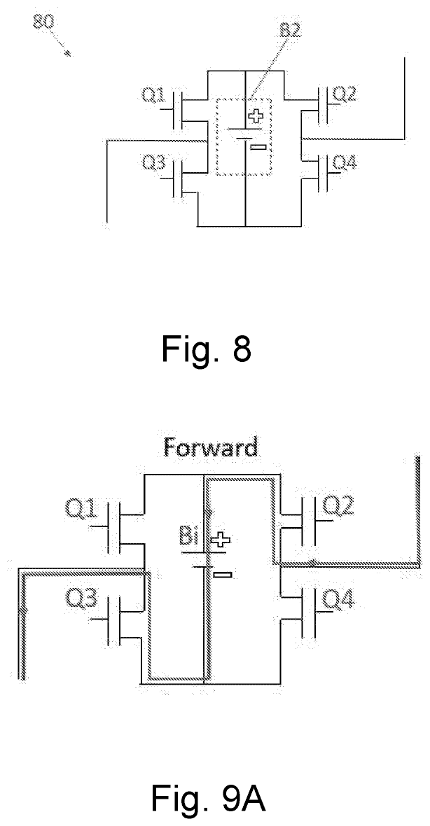

FIG. 8 illustrates a full bridge implementation of a two-port switching circuit required for performing the bypass and polarity flipping operations, according to a preferred embodiment of the invention. The full bridge is implemented for example, by four MOSFETs Q1-Q4 (which are controllable switches), where each of the battery cells Bi (i=1, . . . , n) is connected in the middle of the bridge.

Of course, any kind of controllable switch may be used to implement the full bridge, including a Bipolar (BJT) or a contactor (an electrically-controlled switch used for switching an electrical power circuit).

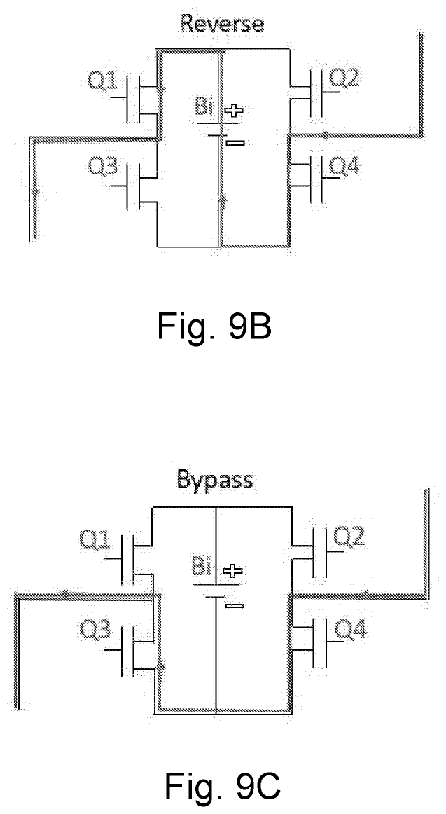

FIGS. 9A-9C illustrate the switching combinations required for performing the bypass and polarity flipping operations, according to a preferred embodiment of the invention. FIG. 9A shows a switching combination for obtaining forward conduction during normal charging of the array. In this case, Q2 and Q3 are controlled to conduct, while Q1 and Q4 are controlled not to conduct. This way, current flows via the array and the weakest battery cell B₂ is being charged normally during the charging mode and being discharged normally during the powering mode.

FIG. 9B shows a switching combination for obtaining reversed conduction during the charging mode of the array, in order to flip the polarity of a weak battery cell B₁. In this case, Q1 and Q4 are controlled to conduct, while Q2 and Q3 are controlled not to conduct. This way, current flows via the array and a weakest battery cell B₂ is being discharged during the charging mode and being charged during the powering mode.

FIG. 9C shows a switching combination for bypassing a weak battery cell Bᵢ, in case it does not function or cannot be charged. In this case, Q1 and Q2 are controlled to not to conduct, while Q2 and Q3 are controlled to conduct. This way, current does not flow via the weakest battery cell Bᵢ, which is effectively bypassed (to allow the connection of two standby battery cells Bₙ₊₁ and Bₙ₊₂ (as described above with respect to FIGS. 6A-6C). Bypassing allows excluding the malfunctioning battery cell B₂ from the array electronically, without the need to remove it physically from the array and replacing it with a functioning battery cell (remove it physically from the array and replacement can be deferred to a later maintenance stage).

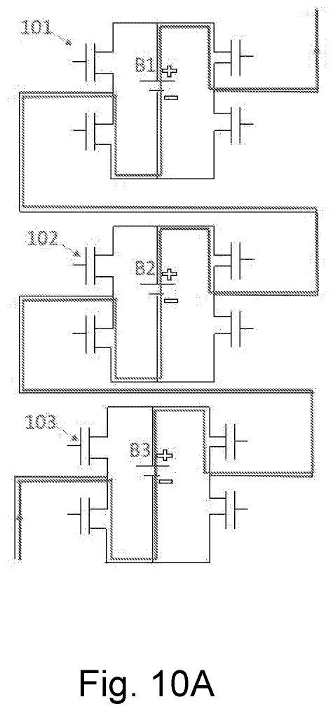

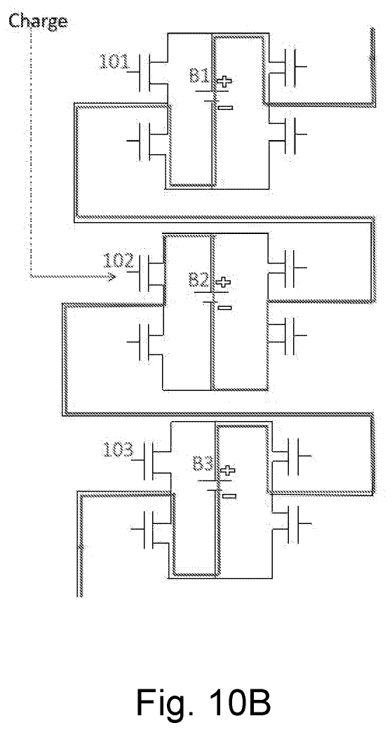

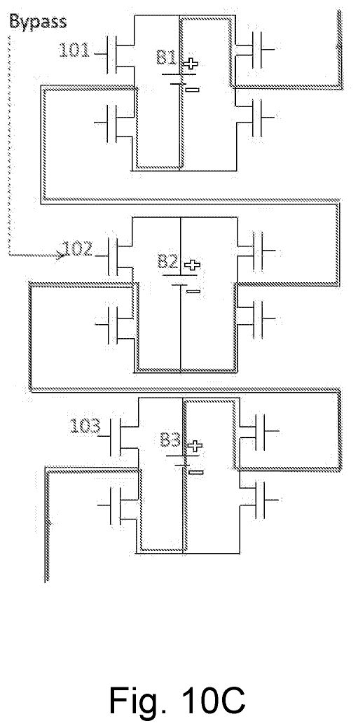

FIGS. 10A-10C illustrate the switching combinations required for performing normal, bypass and polarity flipping operations for an array of three battery cells B₁-B₃ during powering mode, according to a preferred embodiment of the invention. FIG. 10A shows a switching combination for obtaining forward conduction during normal powering mode of the array. In this case, full bridges 101, 102 and 103 are controlled to conduct and allow current to flow into the load, while all three battery cells B₁-B₃ are being discharged normally during the powering mode, to equally contribute energy to the load.

Whenever the exceptional power storage device is bypassed or flipped, the output voltage of the array may be equalized to be within a desired value Vo, by serially connecting a standby equivalent power storage device to the array via a switching circuit.

FIG. 10B shows a switching combination for obtaining polarity flipping of the weakest battery cell B₂ during powering mode of the array. In this case, full bridges 101 and 103 are controlled to conduct and allow current to flow into the load, while full bridge 102 is controlled to flip the polarity of connection of the weakest battery cell B₂ while during the powering mode, battery cells B₁ and B₃ are being discharged, and the weakest battery cell B₂ is being charged.

FIG. 10C shows a switching combination for bypassing the weakest battery cell B₂ during powering mode of the array. In this case, full bridges 101 and 103 are controlled to conduct and allow current to flow into the load from battery cells B₁ and B₃ that are being discharged, while full bridge 102 is controlled to bypass the weakest battery cell B₂.

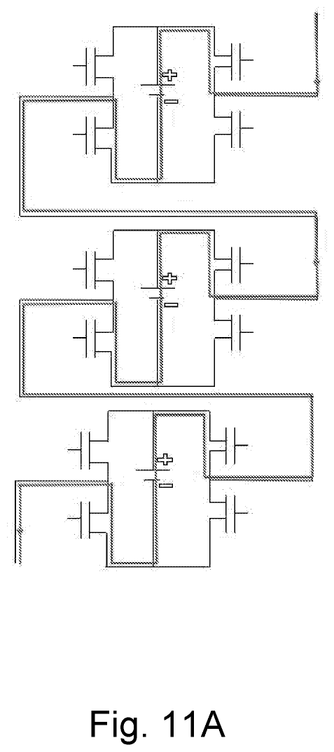

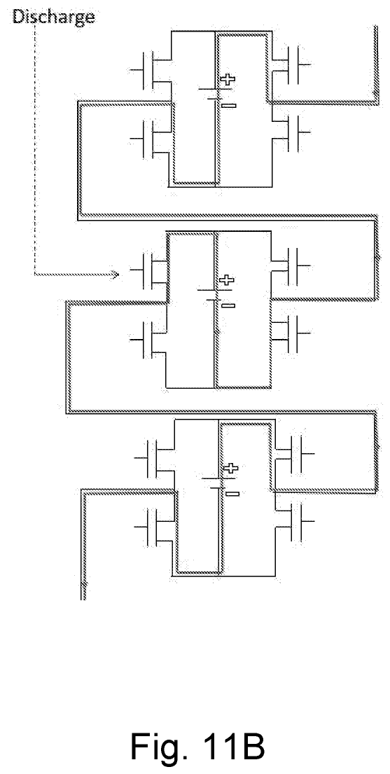

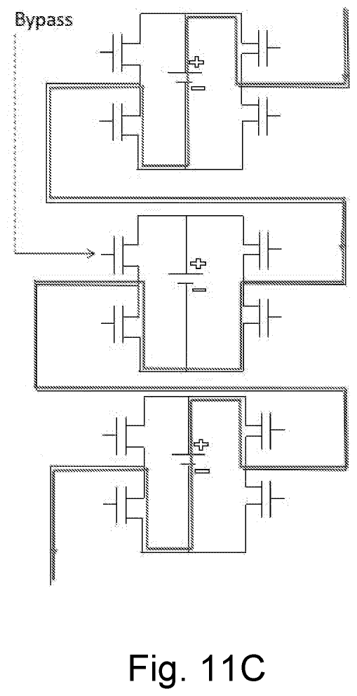

FIGS. 11A-11C illustrate the switching combinations required for performing normal, bypass and polarity flipping operations for an array of three battery cells B₁-B₃ during charging mode, according to a preferred embodiment of the invention. FIG. 11A shows a switching combination for obtaining conduction during normal charging mode of the array. In this case, full bridges 101, 102 and 103 are controlled to conduct and allow current to flow from a charger into the array, while all three battery cells B₁-B₃ are being charged equally.

FIG. 11B shows a switching combination for obtaining polarity flipping of the weakest battery cell B₂ during charging mode of the array. In this case, full bridges 101 and 103 are controlled to conduct and allow current to flow from the charger into the array to charge battery cells B₁ and B₃, while full bridge 102 is controlled to flip the polarity of connection of the weakest battery cell B₂, while full bridges 101 and 103 are controlled to conduct and allow current to flow from a charger into the array to charge battery cells B₁ and B₃.

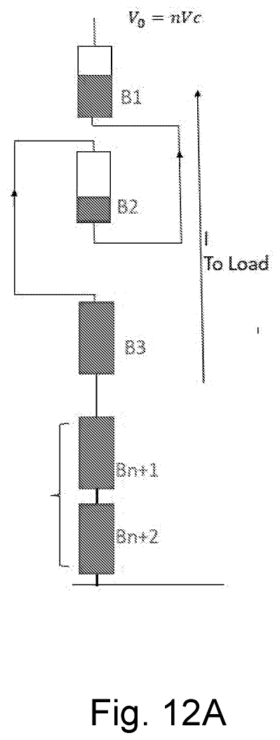

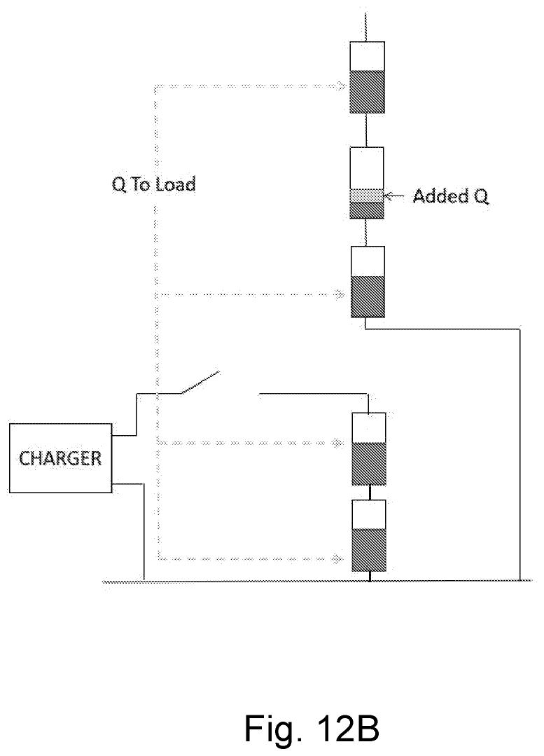

FIGS. 12A and 12B illustrate the remote charging effect accomplished by the flip operation according to the invention. In FIG. 12A, current I is provided to the load by battery cells B₁, B₃, and the standby battery cells Bₙ₊₁ and Bₙ₊₂ (that maintain a constant output voltage Vo=nVc), while during this powering stage, the weakest battery cell B₂ is being charged due to its flipped polarity. During this time, energy is transferred from Bₙ₊₁ and Bₙ₊₂ to B₂ and the load. FIG. 12B shows that at the end of the powering stage, the charger replenishes the missing charge in Bₙ₊₁ and Bₙ₊₂. This means, in a global view, that the charger has in effect charged battery B₂ remotely. Hence, flipping the polarity of the weakest battery cell B₂ during charging and powering modes of the array also allows remote charging of the weakest battery cell B₂ and replenishing its energy, without requiring a charger connection to each battery cell (or module) in the array. Upon detecting (e.g., by a software module) that a specific battery cell is exceptional with respect to the other battery cells, e.g., weaker than the other battery cells, flipping its polarity prevents that weaker battery cell from being a “bottle neck” that limits the capabilities of the entire array.

According to an alternative embodiment, the charger 20 shown in FIG. 12B can be located across any battery cell in the array.

Each power storage device is coupled to a two-port switching circuit and is serially connected to other power storage devices via the two-port switching circuit. During normal operation, the positive port of each power storage device is connected to the negative port of its subsequent power storage device (to form a string of power storage devices), except for the power storage device with the highest voltage point, which is an output terminal of the array.

Generally, upon detecting that an exceptional battery cell in the array has charging or powering characteristics that are outside a predetermined threshold window with respect to the battery cells in the array, this exceptional power storage device is electrically bypassed by directly connecting between the two ports of the switching circuit, while excluding the exceptional battery cells from the connection, or electrically flipping the connection polarity of the exceptional battery cell. Hence, during a powering mode, when the array feeds a load, the exceptional battery cells will be charged by the current supplied to the load via all battery cells of the array. During a charging mode, when the array is charged by a power source, the battery cells will be discharged by the charging current flowing through all the battery cells of the array.

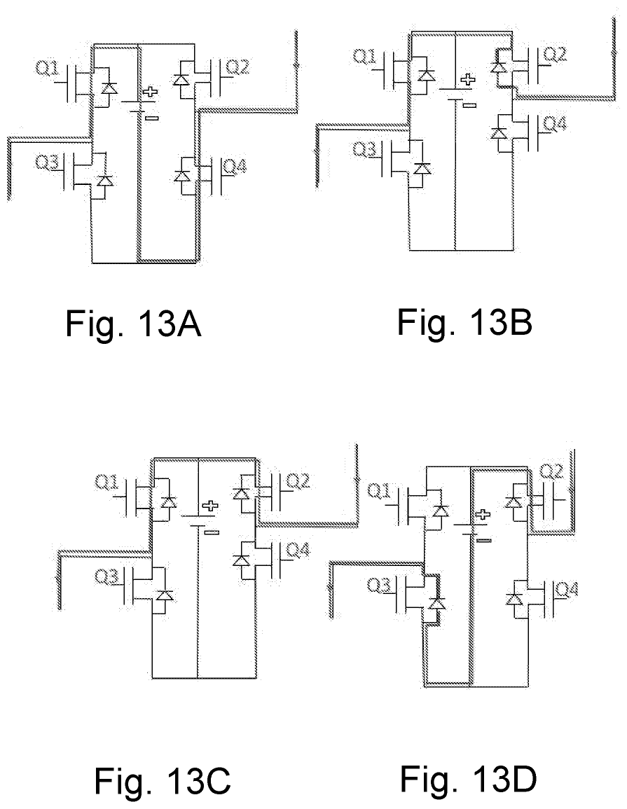

According to another embodiment, flipping the polarity of a weaker battery cell may be performed by the (full bridge) switching circuit using partial soft switching. FIGS. 13A-13D show such a partial soft switching. During normal powering mode operation, Q1 and Q4 conduct and Q2 and Q3 are not conducting, such that battery cell B₂ feeds the load (FIG. 13A). Upon detecting that battery cell B₂ is weak, flipping is reached in steps. At the first step, Q4 is controlled to stop conducting and therefore, the current will flow via the inherent diode of Q2 (FIG. 13B). At the second step, Q2 is controlled to conduct only after the voltage over that inherent diode is low (FIG. 13C). At the third step, Q1 is controlled to stop conducting and the current will flow via battery cell B₂ and the inherent diode of Q3 (FIG. 13D) and Q3 is controlled to conduct only after the voltage over that inherent diode is low. This way, flipping is reached at essentially zero voltage.

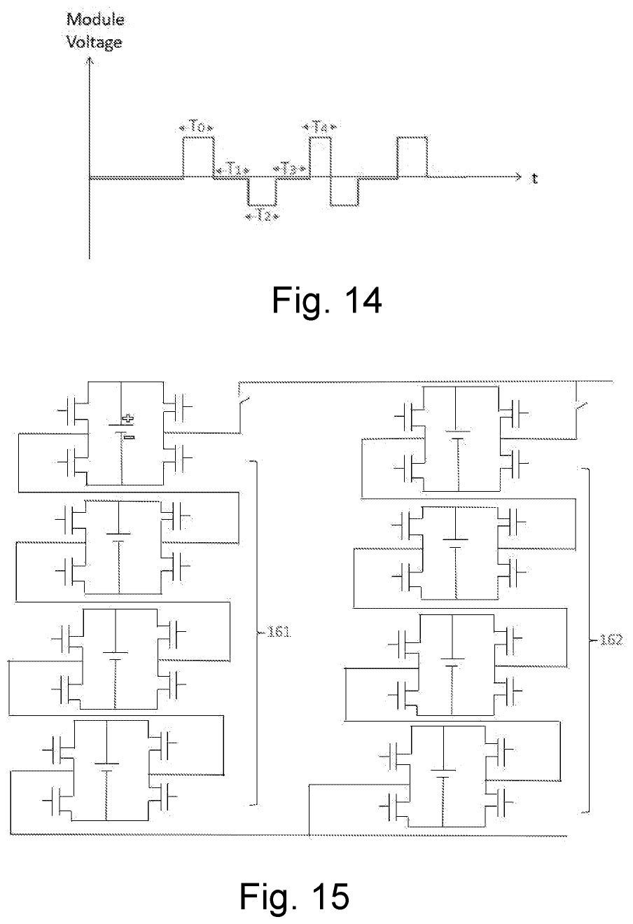

In some cases, it is not recommended to charge the battery cell in the maximum current, for example, if during charging a battery cell heats up. In order to do so, it is possible to charge the battery cell using PWM to eliminate overheating. FIG. 14 shows an example of operating in global PWM during charging mode. It can be seen that at the beginning of a charging cycle, the battery cell is charged for a time period of T₀. Then, charging is stopped for a time period of T₁ by operating the flip switch circuitry in bypass mode. Then, the battery cell is discharged for a time period of T₂. Then, discharging is stopped for a time period of T₃. Then, charging is resumed for a time period of T₄. Such PWM normally extends the battery lifetime.

Some applications require connecting two or more arrays in parallel. This requires that connection will be made only if the output voltages of the connected arrays are essentially equal. FIG. 15 shows a parallel connection of two arrays 161 and 162, each having the capability of flipping the polarity of one or more cells. Therefore, the method proposed by the present invention allows online tuning of the output voltage of an array to comply with the output voltage of other arrays. For example, voltage tuning of an array may be done by bypassing or flipping the polarity of a battery cell in one or more arrays to be connected in parallel.

According to another embodiment, the output voltage of an array can be adjusted by electrically flipping the connection polarity of one or more battery cells in the array, while at the same time, equalizing the charge over all battery cells during charging and powering modes. This embodiment may also include electrically bypassing one or more battery cells in the array, as a part of the voltage adjustment (in this case, there the charge equalization will exclude the bypassed battery cells).

According to another embodiment, the output voltage of the entire array is reversed by electrically flipping the connection polarity of more than half of the power storage devices in the array (or of all the power storage devices), while at the same time, equalizing the charge over all power storage devices during charging and powering modes.

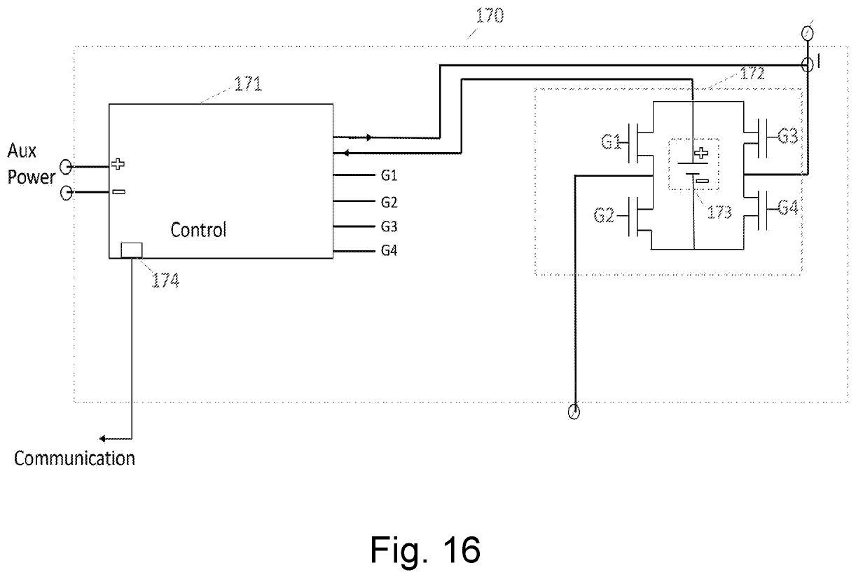

FIG. 16 shows a possible implementation of a flip switch module, according to an embodiment of the invention. The flip switch module 170 comprises a controller 171 which controls the (full bridge) switching circuit 172 by sampling the current and voltage of the battery cell 173. The control outputs G1-G4 of the controller 171 are connected to the gates of the transistors (such as BJTs or MOSFETs or an Insulated-Gate Bipolar Transistors (IGBTs)) implementing the full bridge. The controller 171 may be powered from an external power supply or from the battery cell 173. The flip switch module 170 also comprises a communication port 174 for providing data to a global control system and/or being controlled by a higher level control system.

The above examples and description have of course been provided only for the purpose of illustrations, and are not intended to limit the invention in any way. As will be appreciated by the skilled person, the invention can be carried out in a great variety of ways, employing more than one technique from those described above, all without exceeding the scope of the invention.

1. A method for operating an array of power storage devices having an output voltage Vo, each having a positive port and a negative port, comprising:
a) providing an array of power storage devices, each of which being coupled to a two-port switching circuit and being serially connected to each other via said two-port switching circuit, such that during normal operation, the positive port of each power storage device is connected to the negative port of its subsequent power storage device, except for the power storage device having the highest voltage point, which is an output terminal of the array;
b) upon detecting that an exceptional power storage device in said array has charging or powering characteristics that are outside a predetermined threshold window with respect to the remaining power storage devices in said array:
b.1) electrically bypassing said exceptional power storage device by directly connecting between the two ports of the switching circuit of said power storage, while excluding said exceptional power storage device from the connection, or;
b.2) electrically flipping, by said two-port switching circuit, the connection polarity of said exceptional power storage device, such that during a powering mode, when said array feeds a load, said exceptional power storage device will be charged by the current supplied to said load via all power storage devices of said array and during a charging mode, when said array is charged by a power source, said exceptional power storage device will be discharged by the charging current flowing through all the power storage devices of said array.

2. A method according to claim 1, further comprising whenever the exceptional power storage device is bypassed or flipped, equalizing the output voltage of the array to be within a desired value Vo by serially connecting a standby equivalent power storage device to said array via a switching circuit.

3. A method according to claim 1, further comprising:
whenever the connection polarity of the exceptional power storage device is flipped, equalizing the output voltage of the array to be Vo by serially connecting two standby equivalent power storage devices to said array via a switching circuit; and
during powering mode, charging the standby equivalent power storage devices after connection to the array, via a power source being referred to a predetermined reference voltage.

4. (canceled)

5. A method according to claim 3, wherein the predetermined reference voltage is ground.

6. A method according to claim 1, wherein the two-port switching circuit is a full bridge consisting of:
two pairs of serially connected controllable switches, said two pairs are parallelly connected to each other and to the ports of the power storage device;
a first port being connected to the mutual connection of one pair; and
a second port being connected to the mutual connection of the other pair.

7. A method according to claim 1, wherein the controllable switches are selected from the group of:
transistors;
contactors.

8. A method according to claim 1, wherein the power source is a charger being referred to a predetermined reference voltage or to ground.

9. A method according to claim 1, wherein the power storage device is selected from the group of:
a rechargeable battery;
a super capacitor;
a fuel cell.

10. A method according to claim 8, wherein the rechargeable battery is a second life battery.

11. A method according to claim 6, wherein the transistors are BJTs or MOSFETs or IGBT.

12. A method according to claim 5, further comprising performing soft switching in the two-port switching circuit whenever the controllable switches are MOSFETs, each having an inherent diode, by:
a) controlling one MOSFET not to conduct while allowing current to initially flow via its inherent diode;
b) controlling said MOSFET to conduct after the voltage over said inherent diode drops toward zero voltage.

13. A method according to claim 1, wherein charging is performed using PWM, including a combination of predetermined charging time periods in maximum current and predetermined charging time periods in zero current and optionally predetermined charging time discharging periods.

14. A method according to claim 1, further comprising:
a) adjusting the output voltages of two or more arrays by electrically bypassing one or more power storage device in at least one array, to have essentially similar output voltages;
b) adjusting the output voltages of two or more arrays by electrically flipping the connection polarity of one or more power storage device in at least one array, to have essentially similar output voltages; and
c) connecting one or more arrays having adjusted output voltages in parallel.

15. A method according to claim 5, wherein each full bridge is controlled by a control circuit having a communication port, said control circuit being fed externally from the power storage device connected to said full bridge and is adapted to sample the voltage and the charging/powering current of said power storage device.

16. A method according to claim 1, wherein the output voltage of the entire array is reversed by electrically flipping the connection polarity of more than half of the power storage devices in the array, while at the same time, equalizing the charge over all power storage devices during charging and powering modes.

17. A method for operating an array of power storage devices having an output voltage Vo, each having a positive port and a negative port, comprising:
a) providing an array of power storage devices, each of which being coupled to a two-port switching circuit and being serially connected to each other via said two-port switching circuit, such that during normal operation, the positive port of each power storage device is connected to the negative port of its subsequent power storage device, except for the power storage device having the highest voltage point, which is an output terminal of the array;
b) whenever required:
b.1) electrically bypassing said exceptional power storage device by directly connecting between the two ports of the switching circuit of said power storage, while excluding said exceptional power storage device from the connection, or;
b.2) electrically flipping, by said two-port switching circuit, the connection polarity of said exceptional power storage device, such that during a powering mode, when said array feeds a load, said exceptional power storage device will be charged by the current supplied to said load via all power storage devices of said array and during a charging mode, when said array is charged by a power source, said exceptional power storage device will be discharged by the charging current flowing through all the power storage devices of said array.

18. A system for operating an array of power storage devices having an output voltage, comprising:
a) an array of power storage devices, each of which being coupled to a two-port switching circuit and being serially connected to each other via said two-port switching circuit, such that during normal operation, the positive port of each power storage device is connected to the negative port of its subsequent power storage device, except for the power storage device having the highest voltage point, which is an output terminal of the array;
b) a controller for controlling each of said two-port switching circuit, which is adapted to:
c) detect that an exceptional power storage device in said array has charging or powering characteristics that are outside a predetermined threshold window with respect to the remaining power storage devices in said array;
d) electrically bypass said exceptional power storage device by directly connecting between the two ports of the switching circuit of said power storage, while excluding said exceptional power storage device from the connection, or;
e) electrically flip, by said two-port switching circuit, the connection polarity of said exceptional power storage device, such that during a powering mode, when said array feeds a load, said exceptional power storage device will be charged by the current supplied to said load via all power storage devices of said array and during a charging mode, when said array is charged by a power source, said exceptional power storage device will be discharged by the charging current flowing through all the power storage devices of said array.

19. A system according to claim 18, further comprising:
a) a standby equivalent power storage device;
b) a switching circuit for connecting and disconnecting said standby equivalent power storage device from the array,
wherein whenever the exceptional power storage device is bypassed or flipped by the controller, the controller equalizes the output voltage of the array to be within a desired value Vo by serially connecting said standby equivalent power storage device to the array.

20. A system according to claim 18, further comprising a power source being referred to a predetermined reference voltage or to ground, for charging said standby equivalent power storage device upon or after serially connecting the standby equivalent power storage device to the array.

21. A controlled power storage apparatus having a positive port and a negative port, comprising:
a) a power storage device having a positive port and a negative port;
b) a two-port controllable switching circuit, to which said positive and negative ports are coupled, said two-port switching circuit having control inputs and being adapted to;
b.1) upon receiving a first set of control commands at said control inputs, connect said positive port to a first port of said power storage device and said negative port to a second port of said switching circuit;
b.2) upon receiving a second set of control commands, electrically bypass said power storage device by controlling said control inputs to directly connect between the two ports of said switching circuit; and
b.3) upon receiving a third set of control commands, connect said negative port to said first port of said switching circuit and said positive port to said second port of said switching circuit, to thereby electrically flip the connection polarity of said power storage device.
